(19) United States
(12) Patent Application Publication
(10) Pub. No.: US 2003/0214438 A1
(43) Pub. Date: Nov. 20, 2003

(54) Broadband I-slot microstrip patch antenna

(76) Inventors: Robert Jason Hatch, San Diego, CA (US); Ernest T. Ozaki, Poway, CA (US); Ahmad Jalali, San Diego, CA (US); Neil Scott Eaves, San Diego, CA (US); David Michael Bahnemann, San Diego, CA (US); Steven Joseph Lundgren, Ramona, CA (US)

Correspondence Address: Qualcomm Incorporated, Patents Department, 5775 Morehouse Drive, San Diego, CA, 92121-1714, US

(21) Appl. No.: 10/151,779

(22) Filed: May 20, 2002

(51) Int. Cl. H01Q 1/38; H01Q 21/00

(52) U.S. Cl. 343/700 MS; 343/853

(57) ABSTRACT

Systems and techniques are disclosed wherein for generating a beam from an antenna. The antenna includes an antenna feed with a first surface having a feed network and a second surface supporting one or more radiating elements. The antenna can include a slot figuration formed in the second surface which couples the feed network to the radiating elements. The antenna feed also be constructed with a thermoplastic or other suitable material. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### BACKGROUND

1. Field

The present invention relates generally to communications systems, and more specifically, to broadband I-slot microstrip patch antennas for communications devices.

2. Background

The demand for broadband internet service to the home has significantly increased in the past few years. Cable and DSL service operators are finding it difficult to keep pace with this demand. At the same time deployment to new customers is proving to be very costly. One way to avoid the high costs of a wired deployment is to offer internet access via wireless communication links. This is currently being done for large scale business applications, but line-of-sight conditions and large expensive high performance antennas and electronics are generally required to maintain the high data rates that are typical for this type of service. Hence, new ways to offer low cost, high speed wireless internet service to the home and business are needed.

### SUMMARY

In one aspect of the present invention, an antenna includes an antenna feed comprising a thermoplastic material having first and second surfaces, the first surface comprising a feed network, and a radiating element supported by the second surface and coupled to the feed network.

In another aspect of the present invention, an antenna includes an antenna feed comprising a thermoplastic material having first and second surfaces, the first surface comprising a feed network, and first and second radiating elements supported by the second surface and coupled to the feed network

In yet another aspect of the present invention, an antenna includes a plurality of antenna feeds each comprising a thermoplastic material having first and second surfaces, the first surface of each of the antenna feeds comprising a feed network, and a plurality of radiating elements, one of the radiating elements being supported by the second surface of each of the antenna feeds.

In a further aspect of the present invention, a method of communications includes generating a beam from an antenna, the antenna having an antenna feed with a thermoplastic material having first and second surfaces, the first surface having a feed network, and a radiating element supported by the second surface and coupled to the feed network.

In yet a further aspect of the present invention, a method of communications includes selecting one section of an antenna from a plurality of antenna sections, each section of the antenna comprising an antenna feed having a thermoplastic material with first and second surfaces, the first surface having a feed network, and a radiating element supported by its respective second surface and coupled to its respective feed network, and generating a beam from the selected antenna section.

In another aspect of the present invention, an antenna includes an antenna feed comprising a substrate material having a first surface with a feed network and a second surface having a conductive material with a slot, and a radiating element supported by the second surface, wherein the slot couples the feed network to the radiating element.

In yet another aspect of the present invention, an antenna includes a plurality of antenna feeds each comprising a substrate material including a first surface having a feed network and a second surface having a conductive material with a slot, and a plurality of radiating elements, each of the radiating elements being supported by the second surface of each of the antenna feeds, wherein each of the slots couples its respective feed network to its respective radiating element.

In a further aspect of the present invention, a method of communications includes generating a beam from an antenna, the antenna having an antenna feed with a substrate material including a first surface having a feed network and a second surface having a conductive material with a slot, and a radiating element supported by the second surface and coupled to the feed network, the generation of the beam comprising exciting the radiating element from the slot formed in the second surface.

It is understood that other embodiments of the present invention will become readily apparent to those skilled in the art from the following detailed description, wherein it is shown and described only exemplary embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings wherein:

FIG. 1 is a perspective view of an exemplary antenna for a computer application;

FIG. 2 is a functional block diagram of the electronic switching function of an exemplary antenna;

FIG. 3A is an exploded perspective front view of an exemplary antenna feed supporting a pair of radiating elements; and

FIG. 3B is a rear view of the exemplary antenna feed shown in FIG. 3A with the front portion shown in phantom.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well known structures and devices are shown in block diagram form in order to avoid obscuring the concepts of the present invention.

In an exemplary embodiment of a communications system, a high performance low cost antenna can be used for broadband applications such as wireless internet access to the home or office. The antenna can be configured to generate a directional beam linking a user to a network access point, while minimizing interference from other sources. The antenna can be equipped with self-alignment capability to provide dynamic repositioning of the beam to optimize performance despite changes in the communications environment. As a result, higher data rates can be supported, which in turn increases the overall throughput of the communications system. The antenna can be constructed with low cost materials while maintaining performance consistent with requirements for high data rate transmissions in residential and business applications.

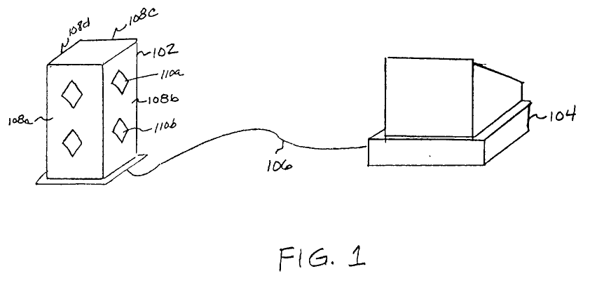

FIG. 1 is a perspective view of an exemplary antenna for residential and business applications. The antenna 102 is shown coupled to a personal computer 104 via an Ethernet cable 106, but could just as easily be coupled to the personal computer 104 through a wireless access point modem integrated into the personal computer 104 or by any other means known in the art. The antenna 102 can be used to exchange data between a wide area network (WAN) and a single or group of computers.

The antenna 102 can be constructed with a rectangular structure having four antenna sections. Each antenna section includes an antenna feed 108a-d. Each antenna feed includes an array of radiating elements 110a and 110b stacked in the elevation plane. This approach tends to increase the directivity of the beam without effecting the coverage in the azimuth plane. In the embodiment shown, each radiating element 110a and 110b can be configured to generate a beam with an azimuthal beamwidth of 90° resulting in 360° of coverage in the azimuth plane with a four antenna section structure. Alternatively, a three antenna section structure can be used with each radiating element 110a and 110b having an azimuthal beamwidth of 120°. Different configurations may employ any number of antenna feeds with radiating elements having various azimuthal beamwidths to provide of 360° of coverage, or less, depending on the particular communications application and the overall design constraints. Alternatively, a continuous cylindrical antenna feed, or similar structure, with radiating elements spaced apart along its circumference may be used. Moreover, the number of radiating elements employed in each array is application dependent and those skilled in the art will be readily able to assess performance and cost tradeoffs to determine the optimal arrangement for any given application.

Beam steering capability can be realized by electronically switching the beam between the four antenna sections. Alternatively, the antenna can be constructed with an array of radiating elements on a single antenna feed and rotated by a motor (not shown) integrated into the antenna. In any case, a processor (not shown) can be used to direct the beam to provide optimal performance in terms of signal to interference plus noise ratio (SINR). In electronically switched beam architectures, a microwave switch (not shown) can be used to select the direction having optimum SINR under processor control. The switched beam architecture also provides flexibility for independent steering of forward and reverse link transmissions. The forward link refers to transmissions from a network access point to the user, and the reverse link refers to transmissions from the user to the network access point.

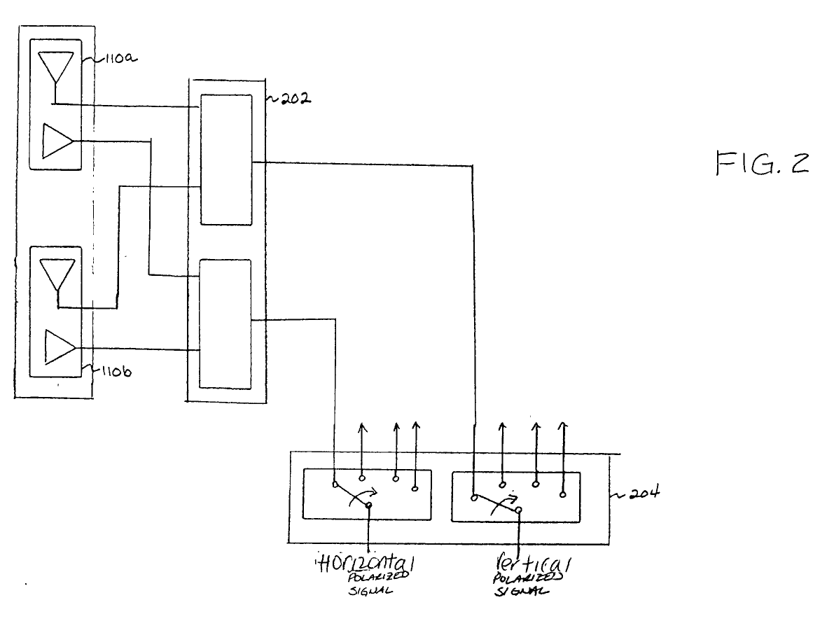

FIG. 2 is a functional block diagram of the electronic switching function of the antenna. For the purposes of illustration, the electronic switching function will be described in connection with an antenna having dual orthogonal polarization. This approach tends to further improve the SINR, as well as provide good port isolation, due to diversity. However, as those skilled in the art will readily appreciate, the innovative antenna concepts described herein can be practiced with a single beam antenna. Referring to FIG. 2, an array of dual polarized radiating elements 110a and 110b are shown mounted on the selected antenna section. A combiner network 202 can be used to combine corresponding polarized signals from each radiating element 110a and 110b in the elevation plane. A microwave switch 204 can be used to direct the polarized signals from the selected antenna section to the user. The microwave switch 204 can be a SP4T switch, or any other similar device known in the art. The switch can be controlled by a processor (not shown) in a way to ensure that the beam is directed towards the network access point and away from other sources of noise and interference. This can be done by sweeping the beam pattern 360° in azimuth during idle periods to find the optimal SINR, or by other means well known in the art.

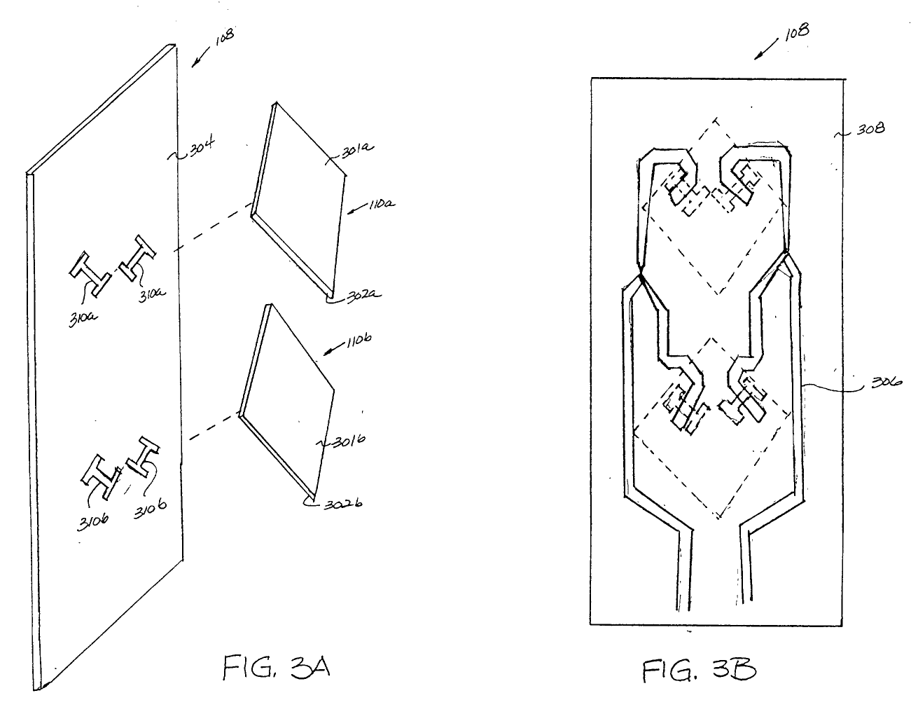

FIG. 3A is an exploded perspective front view of an exemplary antenna feed supporting a pair of radiating elements. FIG. 3B is a rear view of the exemplary antenna feed shown in FIG. 3A with the front portion shown in phantom. The antenna feed 108 includes an array of microstrip patch elements 110a and 110b each having a conductor 301a and 301b etched on a dielectric substrate material 302a and 302b and suspended above the antenna feed 108. The front surface 304 of the antenna feed 108 can be a conductive surface, which serves not only as a ground plane for the microstrip patch elements 110a and 110b, but also provides a ground plane for a feed network 306 on the rear surface of the antenna feed 308. The feed network 306 can be implemented with microstrip lines. The feed network 306 can be dielectrically coupled to a pair of slots 310a and 310b cut into the front surface 304 of the antenna feed 108 for each microstrip patch element. The slots 310a and 310b provide a means for exciting the microstrip patch elements 110a and 110b. Fixed tilting of the beam in the elevation plane can be implemented by extending the microstrip line feeding the top microstrip patch element relative to the bottom microstrip patch element. This may improve performance for desktop mounted installations.

The antenna feed 108 and microstrip patch elements 110a and 110b can be constructed from various substrate materials. Typically, antenna feeds and patch elements are implemented with low loss microwave materials which are expensive. However, since the exemplary embodiments described thus far do not require solder, the field of choices can be expanded to include low cost thermoplastics. One such material is polycarbonate which costs less than traditional microwave material, yet has good loss characteristics. By using polycarbonate, or other thermoplastic materials, an antenna can be implemented with very low cost but with the performance required to support high data rate transmissions in residential and business applications.

The use of a thermoplastic material may also reduce the weight and size of the antenna over traditional approaches. First, the antenna feed can double as a plastic support structure, which not only reduces size, but results in a very cost efficient package. Second, the dielectric constant of many thermoplastics allows the use of a relatively thin substrate material for the feed and patch element while maintaining good performance in terms of bandwidth and peak gain. This is because these performance parameters are a function of both the dielectric constant and the thickness of the substrate material. Polycarbonate has about the right amount of dielectric loading so that the bandwidth and peak gain parameters can be optimized with minimal thickness, thereby reducing the overall size of the feed and patch elements. Moreover, by dielectrically loading the patch elements, the beamwidth can be increased over conventional air loaded patch elements to provide 90° of coverage in the azimuth plane.

The patch element 110 may be implemented in various fashions depending on the overall design parameters and system requirements. In broadband applications, the thickness of the patch element should be sufficient to support the required bandwidth. However, to maintain good coupling to the patch element, the slot length should also be increased correspondingly with any increase in thickness of the patch element. For antennas with a 10% bandwidth requirement, the slot length will generally extend beyond half the width of the patch element. This approach is suitable for single beam antenna applications.

In antenna applications with dual orthogonal polarization, two orthogonally spaced slots are used to excite the patch element. Accordingly, a 10% bandwidth requirement will result in the two slots intersecting one another, thereby reducing the port decoupling to 7 dB. This contributes 1 dB to the overall antenna losses. One way to increase the port decoupling is to shorten the slots such that they no longer intersect in a way that does not reduce the amount of energy coupled to the patch element. This can be accomplished by maintaining a relatively uniform electric field throughout each slot. Typically, the electric field is at a maximum at the center of the slot and continually decays toward the ends. By adding short perpendicular slots to both ends of a rectangular slot, a relatively uniform electric field throughout the slot can be achieved thereby increasing the energy coupled to the patch element for a given length. The resulting I shaped slots can then be shorter than rectangular slots while coupling the same amount of energy to the patch element.

Maximum coupling efficiency can be obtained by aligning the longitudinal axes of the slots along the center of the patch element. In certain applications in which the bandwidth requirements results in the end pieces of the I slots intersecting when aligned for maximum coupling efficiency, a slight movement of one or both slots perpendicular to its respective longitudinal axis may avoid the intersection of the two slots without significantly reducing the energy coupled from the slot to the patch element. A small gap between the slots may result in greater than 15 dB of port decoupling.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An antenna, comprising:
an antenna feed comprising a thermoplastic material having first and second surfaces, the first surface comprising a feed network; and
a radiating element supported by the second surface and coupled to the feed network.

2. The antenna of claim 1 wherein the thermoplastic material comprises polycarbonate.

3. The antenna of claim 1 wherein the second surface comprises a conductive material having a slot coupling the feed network to the radiating element.

4. The antenna of claim 1 wherein the second surface comprises a conductive material having first and second slots coupling the feed network to the radiating element.

5. The antenna of claim 4 wherein the first and second slots are arranged orthogonal to one another.

6. The antenna of claim 5 wherein the first and second slots each comprises an I shape.

7. The antenna of claim 6 wherein the first and second slots each comprises a longitudinal axis offset from a center of the radiating element.

8. The antenna of claim 1 wherein the radiating element comprises a microstrip patch element.

9. The antenna of claim 8 wherein the radiating element further comprises a conductive material and a second thermoplastic material disposed between the conductive material and the second surface of the antenna feed.

10. The antenna of claim 9 wherein the second thermoplastic material comprises polycarbonate.

11. An antenna, comprising:
an antenna feed comprising a thermoplastic material having first and second surfaces, the first surface comprising a feed network; and
first and second radiating elements supported by the second surface and coupled to the feed network.

12. The antenna of claim 11 wherein the thermoplastic material comprises polycarbonate.

13. The antenna of claim 11 wherein the second surface comprises a first pair of slots coupling the first radiating element to the feed networks, and a second pair of slots coupling the second radiating elements to the second radiating element.

14. The antenna of claim 13 wherein the first pair of slots are arranged orthogonal to one another, and the second pair of slots are orthogonal to one another.

15. The antenna of claim 14 wherein the slots each comprises an I shape.

16. The antenna of claim 15 wherein the first pair of slots each comprises a longitudinal axis offset from a center of the first radiating element, and the second pair of slots each comprises a longitudinal axis offset from a center of the second radiating element.

17. The antenna of claim 11 wherein the first and second radiating elements each comprises a microstrip patch element.

18. The antenna of claim 17 wherein the first and second radiating elements each further comprises a conductive material and a second thermoplastic material disposed between its respective conductive material and the second surface of the antenna feed.

19. The antenna of claim 18 wherein the second thermoplastic material comprises polycarbonate.

20. The antenna of claim 11 wherein the feed network comprises a first combiner configured to couple a first polarized signal to one of the slots in each of the first and second pairs, and a second combiner configured to couple a second polarized signal to the other one of the slots in each of the first and second pairs.

21. An antenna, comprising:
a plurality of antenna feeds each comprising a thermoplastic material having first and second surfaces, the first surface of each of the antenna feeds comprising a feed network; and
a plurality of radiating elements, one of the radiating elements being supported by the second surface of each of the antenna feeds.

22. The antenna of claim 21 wherein the thermoplastic material comprises polycarbonate.

23. The antenna of claim 21 wherein the second surface of each of the antenna feeds comprises a conductive material having a slot coupling the feed network to the radiating element.

24. The antenna of claim 21 wherein the second surface of each of the antenna feeds comprise a conductive material having first and second slots coupling their respective feed network to their respective radiating element.

25. The antenna of claim 24 wherein the first and second slots of each of the antenna feeds are arranged orthogonal to one another.

26. The antenna of claim 24 wherein the slots each comprises an I shape.

27. The antenna of claim 26 wherein the slots each comprises a longitudinal axis offset from a center of its respective radiating element.

28. The antenna of claim 21 wherein the radiating elements each comprises a microstrip patch element.

29. The antenna of claim 28 wherein the radiating elements each further comprises a conductive material and a second thermoplastic material disposed between the conductive material and the second surface of its respective antenna feed.

30. The antenna of claim 29 wherein the second thermoplastic material comprises polycarbonate.

31. The antenna of claim 21 further comprising a switch configured to selectively couple one of the antenna feeds to a communications device.

32. The antenna of claim 21 wherein the antenna feeds are arranged to form a support structure for the antenna.

33. The antenna of claim 32 wherein the antenna feeds are arranged as a rectangular support structure.

34. A method of communications, comprising generating a beam from an antenna, the antenna having an antenna feed with a thermoplastic material having first and second surfaces, the first surface having a feed network, and a radiating element supported by the second surface and coupled to the feed network.

35. The method of claim 34 wherein the thermoplastic material comprises polycarbonate.

36. The method of claim 34 wherein the generation of the beam comprises exciting the radiating element from a slot formed in the second surface.

37. The method of claim 34 wherein the beam comprises a dual orthogonal beam.

38. The method of claim 37 wherein the generation of the dual orthogonal beam comprises exciting the radiating element from a pair of I shaped slots formed in the second surface.

39. The method of claim 34 wherein the antenna further comprises a second radiating element supported by the second surface and coupled to the feed network, and wherein the generation of the beam comprises generating a dual orthogonal beam from each of the radiating elements.

40. The method of claim 39 wherein the generation of the dual orthogonal beams comprises exciting each of the radiating elements from a respective pair of I shaped slots formed in the second surface.

41. The method of claim 40 further comprising combining energy of the dual orthogonal beams in elevation.

42. A method of communications, comprising:
selecting one section of an antenna from a plurality of antenna sections, each section of the antenna comprising an antenna feed having a thermoplastic material with first and second surfaces, the first surface having a feed network, and a radiating element supported by its respective second surface and coupled to its respective feed network; and
generating a beam from the selected antenna section.

43. The method of claim 42 wherein the thermoplastic material comprises polycarbonate.

44. The method of claim 42 wherein the generation of the beam comprises exciting the radiating element of the selected antenna section from a slot formed in the second surface of its respective antenna feed.

45. The method of claim 42 wherein the beam comprises a dual orthogonal beam.

46. The method of claim 45 wherein the generation of the dual orthogonal beam comprises exciting the radiating element of the selected antenna section from a pair of I shaped slots formed in the second surface of its respective antenna feed.

47. The method of claim 42 wherein each section of the antenna further comprises a second radiating element coupled to the feed network of its respective antenna feed, and wherein the generation of the beam comprises generating a dual orthogonal beam from each of the radiating elements of the selected antenna section.

48. The method of claim 47 wherein the generation of the dual orthogonal beams comprises exciting each of the radiating elements of the selected antenna section from a pair of I shaped slots formed in the second surface of their respective antenna feed.

49. The method of claim 48 further comprising combining energy of the dual orthogonal beams from the selected antenna section in elevation.

50. The method of claim 42 further comprising selecting a second one of the antenna sections, and generating the beam from the second one of the antenna sections.

51. The method of claim 42 wherein the beam comprises a beamwidth of 90° in azimuth.

52. The method of claim 51 further comprising selecting a second one of the antenna sections, and generating the beam from the second one of the antenna sections, wherein beam from the second one of the antenna section comprises a beamwidth of 90° in azimuth.

53. An antenna, comprising:
an antenna feed comprising a substrate material having first surface with a feed network and a second surface having a conductive material with a slot; and
a radiating element supported by the second surface;
wherein the slot couples the feed network to the radiating element.

54. The antenna of claim 53 wherein the substrate material comprises a thermoplastic material.

55. The antenna of claim 54 wherein the thermoplastic material comprises polycarbonate.

56. The antenna of claim 53 wherein the conductive material further comprises a second slot coupling the feed network to the radiating element.

57. The antenna of claim 56 wherein the slots are arranged orthogonal to one another.

58. The antenna of claim 57 wherein the slots each comprises an I shape.

59. The antenna of claim 58 wherein the slots each comprises a longitudinal axis offset from a center of the radiating element.

60. The antenna of claim 53 wherein the radiating element comprises a microstrip patch element.

61. The antenna of claim 60 wherein the radiating element further comprises a second conductive material and a thermoplastic material disposed between the second conductive material and the conductive material of the antenna feed.

62. The antenna of claim 61 wherein the thermoplastic material comprises polycarbonate.

63. An antenna, comprising:
a plurality of antenna feeds each comprising a substrate material including a first surface having a feed network and a second surface having a conductive material with a slot; and
a plurality of radiating elements, one of the radiating elements being supported by the second surface of each of the antenna feeds;
wherein each of the slots couples its respective feed network to its respective radiating element.

64. The antenna of claim 63 wherein the substrate material comprises a thermoplastic material.

65. The antenna of claim 64 wherein the thermoplastic material comprises polycarbonate.

66. The antenna of claim 63 wherein the conductive material of each of the antenna feeds comprise a second slot coupling the its respective feed network to its respective radiating element.

67. The antenna of claim 66 wherein the slots of each of the antenna feeds are arranged orthogonal to one another.

68. The antenna of claim 67 wherein the slots each comprises an I shape.

69. The antenna of claim 68 wherein the slots each comprises a longitudinal axis offset from a center of its respective radiating element.

70. The antenna of claim 63 wherein the radiating elements each comprises a microstrip patch element.

71. The antenna of claim 70 wherein the radiating elements each further comprises a conductive material and a thermoplastic material disposed between the conductive material and the second surface of its respective antenna feed.

72. The antenna of claim 71 wherein the second thermoplastic material comprises polycarbonate.

73. The antenna of claim 63 further comprising a switch configured to selectively couple one of the antenna feeds to a communications device.

74. The antenna of claim 63 wherein the antenna feeds are arranged to form a support structure for the antenna.

75. The antenna of claim 74 wherein the antenna feeds are arranged as a rectangular support structure.

76. A method of communications, comprising generating a beam from an antenna, the antenna having an antenna feed with a substrate material including a first surface having a feed network and a second surface having a conductive material with a slot, and a radiating element supported by the second surface and coupled to the feed network, the generation of the beam comprising exciting the radiating element from the slot formed in the second surface.

77. The method of claim 76 wherein the substrate material comprises a thermoplastic material.

78. The method of claim 77 wherein the thermoplastic material comprises polycarbonate.

79. The method of claim 76 wherein the beam comprises a dual orthogonal beam.

80. The method of claim 79 wherein the generation of the dual orthogonal beam comprises exciting the radiating element from a second slot formed in the second surface.

81. The method of claim 80 wherein the slots each comprises an I shape.
